(19) United States
(12) Patent Application Publication
(10) Pub. No.: US 2011/0044510 A1
(43) Pub. Date: Feb. 24, 2011

(54) OPTICAL CONTROL METHOD FOR FURTHER PRINT PROCESSING

(75) Inventor: Carl Conrad Maeder, Hittnau (CH)

Correspondence Address: PAULEY PETERSEN & ERICKSON, 2800 WEST HIGGINS ROAD, SUITE 365, HOFFMAN ESTATES, IL, 60169, US

(73) Assignee: FERAG AG, HINWIL (CH)

(21) Appl. No.: 12/736,608

(22) PCT Filed: May 13, 2009
(86) PCT No.: PCT/CH2009/000157

§ 371 Date: Oct. 23, 2010

(51) Int. Cl. G06K 9/00

(52) U.S. Cl. 382/112

(57) ABSTRACT

Optical control method and apparatus for application in the further print processing of large-area printed products, in which the large-area printed products are moved along a conveyance path past at least one optical sensor (16). The optical sensor herein detects current images (22) which show at least sections of the conveyance means which have the irregularities (42). The current images (22) form actual values in an image processing unit, which are compared to at least one previously defined set-value. The image processing unit detects the irregularities as such and generates at least one signal, corresponding to the result of a comparison.

### BACKGROUND OF THE INVENTION

1. Field of the Invention

The present invention falls into the field of the postpress processing of printed products and relates to a method for the optical detection of irregularities during the postpress processing of flat print shop products according to the preamble of patent claim 1, and also to an apparatus for the optical detection of irregularities during the postpress processing of flat print shop products according to the preamble of patent claim 12.

2. Discussion of Related Art

US 2006/0147092 A1 discloses the fact that, during the processing of flat print shop products, optical registration systems are employed in order to be able to meet the continuously increasing demands on quality. Here, the print shop products are led by a conveying means past at least two optical sensors, which create current recordings of the print shop products. These recordings are digitized and, in an image processing unit, are compared with images from a reference state of the print shop products, these images having been recorded at various angles. A signal is generated depending on the result of the image comparison.

US 2005/0105766 A1 discloses a method for the identification of individual letters and letters sticking to one another in the specialist area of mail processing. In this case, an optical sensor registers a current image with a single letter or a plurality of letters sticking to one another, which in each case form an object, and uses a contour extraction function to calculate the contour of the object. If the contour of the object has a substantially constant one-dimensional dimension, then this is interpreted as a single letter, while an object having a non-constant width is interpreted as a bundle of a plurality of letters sticking to one another.

EP 0685420 discloses a control method operating with optical sensors at the delivery rate of a conveying apparatus in order to detect missing components of print shop products during the production of the latter. To this end, an optical sensor assigned to each component supply in each case records a current image. An image processing unit compares each current image with corresponding stored calibration images. If a current image differs from the corresponding calibration image, a control or alarm signal is generated.

As distinct from EP 0685420, EP 0700853 A1 additionally discloses the possibility of replacing a reference image recorded for the purpose of comparison and stored in a memory with a current image. To this end, the current image registered by the optical sensor is made the reference image for future comparisons.

### SUMMARY OF THE INVENTION

The common factor in all these methods is that, in practice, print shop products having defects and/or contaminants are registered by the at least one optical sensor and, during subsequent image processing, are interpreted by the detection system as defective print shop products. As a result, the postpress processing cycle is interrupted or the print shop products considered to be defective are removed before the postpress processing thereof. In the event of closer consideration, however, the print shop products considered to be defective by the detection system often prove to be defect-free or at least tolerable, for which reason they are fed back into the postpress processing cycle if possible, which is often done manually. Both variants reduce the cost-effectiveness of the postpress processing in an undesired way.

It is therefore an object of the present invention to increase the reliability of detection of actually defective print shop products.

The problem on which the invention is based for the method is solved by the features of patent claim 1. Further embodiments are the object of the dependent patent claims 2 to 11.

In the method according to the invention for detecting irregularities during the postpress processing of flat print shop products, the latter are led by a conveying means along a conveying path past at least one optical sensor. The at least one optical sensor generates current images which show the print shop products and at least one portion of the conveying means. These current images form actual values in an image processing unit. These actual values are compared in the image processing unit with at least one previously defined reference value, whereupon the image processing unit generates at least one signal depending on a comparison result.

In the following text, print shop products are understood to mean both individual print shop products and groups of a plurality of print shop products. Here, the print shop products each comprise at least one flat, flexible printed product or print shop product, which in turn can comprise a main product and/or at least one part product. Likewise, a print shop product or a plurality of print shop products and/or a printed product or a plurality of printed products or a combination thereof can be put into an envelope. Furthermore, the main product and/or the part product can be inserts of all types, for example a sample of goods.

During the postpress processing of print shop products, contaminants necessarily occur in the form of dust-like dirt, which originates from various sources. A first source of contamination is formed by the friction or the abrasion of elements of the conveying means such as rollers or belts and the print shop products. These are, in particular, ink residues which adhere to the conveying means (for example a conveyor belt), to the conveying element (for example to grippers) and/or to the print shop products. A second source of contamination is formed by the abrasion of adjacent print shop products which touch one another during the postpress processing, for example by their being pushed against one another and resting on one another in an overlapping formation. A further source of dirt is formed by abrasion of the apparatus, which, for example, is formed by belt elements which slide along on a guide bar. A still further source of contamination is formed by the friction or the abrasion of elements of the conveying means, for example rollers or belts, which interact with guides, curved tracks and the like, and/or contamination by lubricants, for example oil spots.

Irrespective of the cause, such dirt is deposited both on stationary and on moving parts and affects their properties, such as sliding coefficients, in a manner that is undesired and difficult to control.

Further irregularities in the sense of the present invention are formed, for example, by contamination of the conveying means in the form of lubricant or printer's ink/ink pigment residues or at least one defect of a conveying means, for example in the form of cracks, holes and/or traces of rubbing of a conveyor belt or conveying compartment. Here, the term irregularities is also understood to mean the combination of two or more such interfering factors. The method can likewise be employed when only one conveying element of a conveying means having a multiplicity of conveying elements in the recording area of the optical sensor is affected by irregularities.

The method is distinguished by the fact that, by means of registering current images which show the print shop products and at least one portion of the conveying means, changes in the conveying means as such can be detected and, during the subsequent comparison of the actual value with the reference value, can be taken into account appropriately. The image processing is carried out in real time in one embodiment. The type of irregularity is not distinguished further in the present invention. By using the method, overall fewer production interruptions and production disruptions and therefore improved cost-effectiveness of the production system can be achieved.

The method can be used flexibly, for example in order to arrange for timely maintenance of a highly contaminated conveying element of the conveying means or in order to remove contamination that is disruptive to further image processing in advance during image pre-processing, in order to improve the reliability of the identification of actually wrongly positioned and/or wrongly assembled print shop products. In the latter case, actually defective print shop products can be detected as such with increased reliability and, in a further embodiment, can be separated out from the further processing process in good time.

If, by using the method, a level of contamination of the conveying means or at least one conveying element thereof is to be monitored, then the at least one signal is used as a basis for deciding about subsequent treatment of the conveying means. This decision is made, for example, in a higher-order control system and permits the timely introduction of suitable countermeasures, for example removal of individual, highly contaminated grippers for the purpose of cleaning, before a certain minimum quality can no longer be ensured during the postpress processing or the entire processing system or part thereof has to be stopped for the purpose of cleaning.

In a further embodiment of the method, the comparison of the actual value with the at least one reference value is not carried out continuously but only periodically, for example always after ten thousand further processed print shop products. To this end, the image processing is appropriately equipped with an internal counting function or a serial number corresponding to the number of print shop products is supplied to the image processing unit. Therefore, the quantity of data can additionally be reduced.

If required, the reference value and/or the result of the comparison by the image processing unit can be transmitted to an appropriately assigned conveying element of the conveying means, for example by a writing station transmitting this information to an RFID transponder of a conveying element, for example of a gripper, assigned to or arranged in/on the conveying element.

If, during further image processing, a contour of a print shop product lying on the conveying means is to be determined by using the actual value, then a constant quality of the conveying means is necessary in order to be able to detect any contour deviations of the print shop product from a previously defined reference value. In this case, the conveying means preferably forms a high-contrast background for the print shop product. For the aforementioned reasons, however, it is not possible in practice to guarantee constant quality of the conveying means, since contamination, wear phenomena and defects can all lead to optically detectable irregularities, which are registered by the optical sensor.

A digitized image typically comprises a large number of image points (pixels). The irregularities are accordingly likewise represented by pixels. In a further method according to the invention, those pixels which represent an irregularity are excluded prior to the further image processing. The further image processing can, for example, comprise contour detection. The excluded pixels are preferably replaced by black pixels if the print shop product registered is located in front of a standardized dark background. Accordingly, the excluded pixels are preferably replaced by white pixels when the registered print shop product is located before a standardized light background. The latter has led to good results in particular during experimental use of back lighting in order to intensify contrast in the contour region of the print shop products.

Depending on the application, however, a single pixel is not sufficiently meaningful to conclude with adequate significance that there are actually irregularities of the conveying means. By using an additional condition which, for example, is formed by the presence of a sufficiently large number of pixels representing an irregularity in a contiguous, adjacent region, the detection rate of the identification of actually wrongly positioned and/or wrongly assembled print shop products during downstream image processing can additionally be increased. In one embodiment of the invention, using a significance unit, the number of pixels representing irregularities identified within a predefined image section is added up and, when an adjustable threshold value is reached, an appropriate signal is generated, which points to the presence of an actual irregularity. To this end, for example in the event of the presence of a pixel representing a potential irregularity, the actual pixel coordinates thereof are compared with the coordinates of previous pixels representing an irregularity and, given a sufficiently small margin, a marking as a region potentially having irregularities is stored in a memory. In one embodiment of the method, the memory and the significance unit are arranged in the image processing unit. Then, if a sufficiently large number of hits occur in this locally limited image section, then it is logged and marked as a region affected by irregularities. Otherwise, the region is classified as correct and treated appropriately during the downstream image processing. As a result of such an avoidance of erroneous classification of the print shop products in the subsequent image processing, for example the position detection, the cost-effectiveness can additionally be increased.

The threshold value for the assessment of the significance is advantageously lower then a deviation defined as impermissible prior to the production operation, since it defines a blind spot on the current image, the content of which is excluded from the further image processing. Otherwise, there is the risk that it is not possible to detect reliably if a component of the print shop product projects beyond a contour of the print shop product. In one application of the method, the threshold value corresponds, for example, to a region measuring 2×2 centimeters on the print shop product. In this example, the print shop product to be inspected contains only one part product. Accordingly, the part product should measure more than 2×2 centimeters, in order that, during the registration of a contrast image by the optical sensor and subsequent contour comparison with a reference image, reliable contour determination and therefore a reliable statement about a defective print shop product can be made.

Depending on the requirement, it is possible to arrange for the image processing unit to generate and/or output the signal in the event of exceeding and/or falling below a tolerance limit and/or the threshold value of the significance. In one embodiment, the tolerance limit corresponds to a maximum contour, within which a print shop product is still deemed to be correct during a contour comparison.

In one embodiment of the method, the at least one reference value is, for example, entered prior to the actual production operation, by an operator entering the reference value via a display belonging to the device for the detection and/or adaptation of irregularities during postpress processing. In a further embodiment, the at least one reference value is called up from a data library and stored in a memory assigned to the image processing unit. Depending on the embodiment, the data library contains manually entered reference values and/or reference values obtained from a setup operation and/or from the production operation. In a further embodiment, the at least one reference value represents at least one reference image, which has usually been registered by the optical sensor prior to the actual production operation.

In one embodiment of the control method, a reference image assigned to a specific conveying element forms the reference value for the comparison of all the current images of the conveying elements, for example the conveying compartments. If each conveying element of the conveying means is assigned a reference image, the precision of the classification—which is to say the detection of actual irregularities—can be improved further.

The common factor in all the control methods according to the invention for the detection of irregularities in postpress processing is that regions of the conveying means or of the at least one conveying elements that are covered by the print shop products are not registered by the optical sensor and are therefore not taken into account either by the image processing unit during the comparison with the at least one reference value. During the creation of a reference image, it is not absolutely necessary for the corresponding conveying element, for example a conveying compartment having a supporting surface, to be empty. During the registration of reference images with empty conveying elements, in particular in the case where a reference image is created for each conveying element, however, non-productive times, such as those which occur during setup operation or when accelerating the apparatus for the production operation, are ideally used for the registration of these reference images.

Many conveying means have antistatic elements, such as antistatic wires in the case of conveyor belts. The antistatic elements are used to prevent or at least to reduce a tendency to disruptive adhesion between the print shop products and the conveying means. They reduce in particular disruptive adhesion of the component of the print shop product that is in direct contact with the conveying means, such as a page or an envelope on one surface of the conveying means. In the case of wire-like antistatic elements, these form an irregularity in images of the conveying means—for example of conveying compartments—which are visible in average digitized images. In the sense of further image pre-processing in order to facilitate downstream image processing, such as position detection and/or contour detection, it is expedient depending on the requirement to remove these antistatic elements from an image registered by the optical sensor, for example a high-contrast silhouette, before this further image processing. The antistatic elements take up a certain number of pixels which, in comparison with an overall number of pixels from the entire recording area of the registered image, is comparatively small, however. Nevertheless, this certain number of pixels influences image noise in an undesired way. In tests, it was shown that such relatively small and/or thin irregularities, which lead to the comparatively small quantities of pixels, may be removed without difficulty from the current image by computation without the information content for the subsequent image processing suffering substantially thereunder. The removal of such negligible pixels is carried out within the context of smoothing. During the smoothing, coarse image structures are maintained and negligibly small irregularities are filtered out. As a result, the quantity of data from a smoothed image, given a sufficiently good image quality for the subsequent image processing, is considerably smaller than that from an un-smoothed digitized image. Ultimately, a reduced quantity of data has a positive effect on the processing speed of the following image processing. Electronic filters such as Gauss filters or median filters are recommended for the smoothing. During the application of the median function, for example, a gray value of a specific pixel is replaced by a median of the gray values from the current environment of this specific pixel.

Depending on the requirement, the smoothing function can be employed before or after the filtering out of the irregularities. In trial operation, good results were achieved if the digitized silhouettes were processed in the context of image conversion for subsequent image processing in the form of contour detection by carrying out the median function before a brightness adjustment.

The irregularities identified as actual irregularities are excluded from downstream image processing, for example edge detection. To this end, in one embodiment of the method, the actual irregularities are learned during a setup operation preceding the effective production operation. Here, all the optically detectable differences between an ideal image formed by the first silhouette and the reference image formed by the second silhouette at the same F/Y coordinates are interpreted as actual irregularities if they exceed the threshold value of the significance required therefor.

In further embodiments of the control method, the increase in the irregularities of the conveying means during the production operation is monitored continuously or periodically, depending on the requirements, for example in each case after one hundred thousand transported print shop products. If the continuous monitoring exceeds a previously defined limiting value of permissible irregularities, depending on the embodiment of the method, a passage of all the conveying elements, empty for this purpose, through the optical sensor is carried out for the purpose of recording new reference images. As a result, the new reference images replace the reference images used for the comparison up to that point. In further embodiments of the control method, silhouettes registered during the production operation replace the corresponding reference images.

The problem on which the invention for the apparatus is based is solved by the features of patent claim 12. Further embodiments are the object of the dependent patent claims 13 and 14.

The apparatus according to the invention for the optical control of flat print shop products has conveying means for conveying the flat print shop products, a digitizing unit and an image processing unit. The conveying means are arranged in such a way that the flat print shop products can be transported therewith along a conveying section past at least one optical sensor. The optical sensor is connected to the image processing unit via the digitizing unit. The image processing unit comprises a comparison function for comparing a digitized current image registered by the optical sensor with at least one reference value. Depending on the requirement, the reference value is stored in a memory or produced for this purpose. By using the result of the comparison, irregularities of the conveying means can be detected as such and can be taken into account appropriately during subsequent image processing. If the subsequent image processing is, for example, contour registration and a comparison with a previously defined permissible position, defective print shop products which go beyond the permissible position can be distinguished reliably from correct print shop products.

In a further embodiment of the apparatus, the image processing unit is connected to a data library.

If required, the image processing unit is connected to a communication means for the output of a signal.

### BRIEF DESCRIPTION OF THE DRAWINGS

The invention will be explained below by using figures, which merely represent exemplary embodiments and in which

FIG. 1 shows a simplified illustration of a first embodiment of the apparatus according to the invention with a correctly positioned print shop product and a wrongly positioned printed product in side view;

FIG. 2 shows a simplified illustration of the apparatus shown in FIG. 1 in a view from above;

FIG. 3 shows a first silhouette which is based on a conveying element of a conveying means that is not affected by irregularities;

FIG. 4 shows a second silhouette which is based on a conveying element of a conveying means that is affected by irregularities;

FIG. 5 shows a pictorial illustration of image pre-processing of the second silhouette; and

FIG. 6 shows a pictorial illustration of further image pre-processing of the first silhouette shown in FIG. 1.

### DESCRIPTION OF PREFERRED EMBODIMENTS

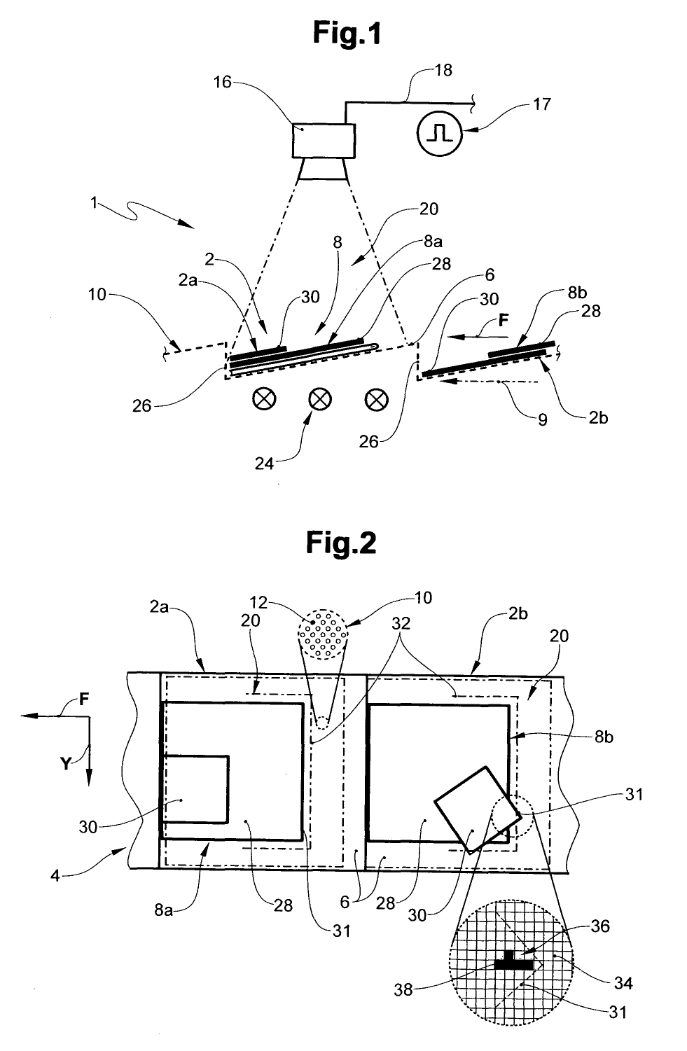

FIG. 1, viewed together with FIG. 2, shows a detail from an apparatus 1 according to the invention, as is described in more detail in the patent application CH . . . /08 filed on the same day by the same applicant and bearing the title “Optical Position Detection”. In FIG. 1, only one of the conveying elements 2 in the form of a conveying compartment 2 of a conveying means 4 is illustrated entirely visibly in side view. The conveying compartment 2 has a supporting surface 6 to accept at least one flat print shop product 8 from a plurality of printed products 8 and is used to transport the print shop products 8 in a conveying direction F along a conveying section 9. The supporting surfaces 6 in the present embodiment are each formed from a textile section and are transparent or translucent. The transparency is increased by a regular perforation 10, and therefore the supporting surfaces 6 are illustrated in simplified form by dotted lines in FIG. 1 while, in FIG. 2, for improved clarity, they are merely illustrated perforated in a detail enlargement. A conveying compartment 2, 2a in the position shown in FIGS. 1 and 2 measures approximately 400 mm in the conveying direction F and approximately 500 mm transversely with respect to the conveying direction F, therefore in the direction Y. The perforation 10 is in this case formed like a perforated plate, which is to say formed with rows of holes offset in each case diagonally by 40 mm with respect to one another with respect to the conveying direction F, a representative hole 12 having a round cross section with a diameter of 8 mm.

Above the conveying means 4, in order to register a silhouette 14, there is arranged an optical sensor 16 which, in order to transmit at least one signal 17, is connected to a signal line 18 for communications purposes. In trial operation, use was made of a so-called low-cost vision sensor having an M12 objective with 8 mm focal length as an optical sensor 16. The processing of the silhouettes was in this case carried out by using an “embedded digital signal processor” of the Blackfin ADSP type with 1000MMACS (not shown), which is connected to a management system (likewise not shown) via an input/output interface (I/O interface) (likewise not shown). The image registration by the optical sensor 16 is carried out in accordance with the machine cycle rate, which is to say the delivery cycle of the conveying compartments 2, 2a of the conveying means 4 in the conveying direction F.

The optical sensor 16 has a specific recording area 20, which restricts a current image in the conveying direction F and transverse direction Y.

Fitted opposite the optical sensor 16, underneath the conveying means 4, is a light-emitting means 24 formed by three fluorescent tubes. During trial operation, use was made of three constantly light-emitting 36 Watt fluorescent tubes with electronic ballast as light-emitting means 24. The light-emitting means 24 forms a contrast light source for the production of silhouettes.

The conveying element/conveying compartment 2, 2a has in each case a supporting surface 6 which is inclined downward in the conveying direction F as seen in side view and which is bounded in the conveying direction F by wall section 26. The inclination is advantageous, since it promotes contact between the print shop products 8 and the wall section 26 and, as a result, forms a stop for the print shop products 8. As a result, a certain positional stability of the print shop products 8 relative to the conveying compartment is promoted. In FIGS. 1 and 2, in each case a print shop product 8 each comprising a part product 28, on which a second part product 30 is arranged in each case, lies on the supporting surfaces 6 of the conveying compartment 2, 2a. In the first conveying compartment 2, located on the left in FIG. 2, the part products 28, 30 lie on the wall section 26 and form a correct print shop product 8a. A correct print shop product 8a is understood to be a correctly assembled print shop product which is aligned correctly with respect to the conveying compartment 2 and with respect to the part products 28, 30. In the second conveying compartment 2b, located on the right in FIG. 2, there lies a print shop product which, although assembled correctly with regard to the composition, the first part product 28 and second part product 30 thereof have been displaced with respect to each other in an undesired way, only the first part product 28 resting on the wall section 26. Therefore, this print shop product 8b will simply be called a defective print shop product 8b below. Those skilled in the art will see that other defective combinations, for example a part product displaced in the transverse direction Y and/or a first and/or second part product having an irregular edge profile, etc., are also possible and can be treated accordingly.

Since, in the present case, the intention is to carry out a control of the position of the print shop products 8a, 8b relative to the conveying compartments 2, 2a, the print shop products 8a, 8b must be smaller than the supporting surface 6 both in the conveying direction F and in the transverse direction Y, in order that the optical sensor 16 is able to register high-contrast silhouettes representing a contour 31 of the print shop products 8a, 8b. In trial operation, good values were achieved with extremely large print shop products 8 to be processed in the DIN A3 format.

Prior to the actual production operation, good values were obtained in tests for reliable detection of actual irregularities on the conveying elements 2, 2b when the threshold value for forming a significance had preferred characteristic values, described below. Since, in the practical case, an outline or an overall contour 31 of each print shop product 8, 8a, 8b forms an important criterion for a foiling system connected downstream in the conveying direction F, a tolerance limit 32 was generated on the basis of a previously determined optimal reference printed product. The tolerance limit 32 has the form of a contour 31 of a correct print shop product but, with respect to the dimensions thereof, is larger in order to tolerate slight positional deviations from an ideal position. In trial operation with print shop products in the DIN A3 format and tolerance ranges ΔF and ΔY of a few millimeters between the contour of an optimal reference print shop product and the tolerance limit 32, good results were achieved. The size of the tolerance range ΔF and ΔY varies depending on the requirement and, for example, is defined by the requirements of a further processing station connected later, as seen downstream. For the purpose of improved understanding of the function of the threshold value for forming a significance, reference will be made below to an illustrative example of the digitized current image, of which the ΔF and ΔY tolerance range respectively measures 5 mm. This 5 mm corresponds to five pixels 34 of the current image, the threshold value having been defined over a contiguous region 36 of at least five pixels 34 and, moreover, these five pixels 34 having to be divided up into at least two rows or columns of pixels.

In a significance unit, which is arranged in an image processing unit, the number of pixels 38 representing irregularities identified within the predefined recording area 20 is added up. The irregularity is then taken into account as such during further image processing only when it exceeds the threshold value of five pixels and is not covered by the print shop product 8.

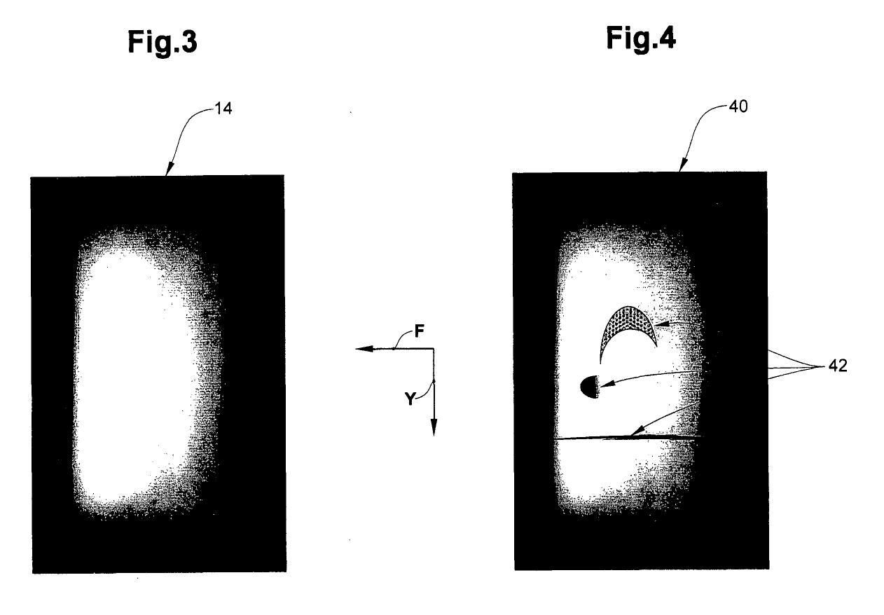

FIG. 3 shows a first silhouette 14, which is based on a conveying compartment of the conveying means not affected by irregularities and without a print shop product, the conveying compartment not being perforated, as distinct from the conveying compartment shown in FIGS. 1 and 2, but merely transparent.

FIG. 4 shows a second silhouette 40 similar to the first silhouette from FIG. 3, the conveying compartment on which the second silhouette 40 is based and which is shown as a detail, as distinct from the ideal conveying compartment, having irregularities 42 in the form of contaminants produced artificially for test purposes.

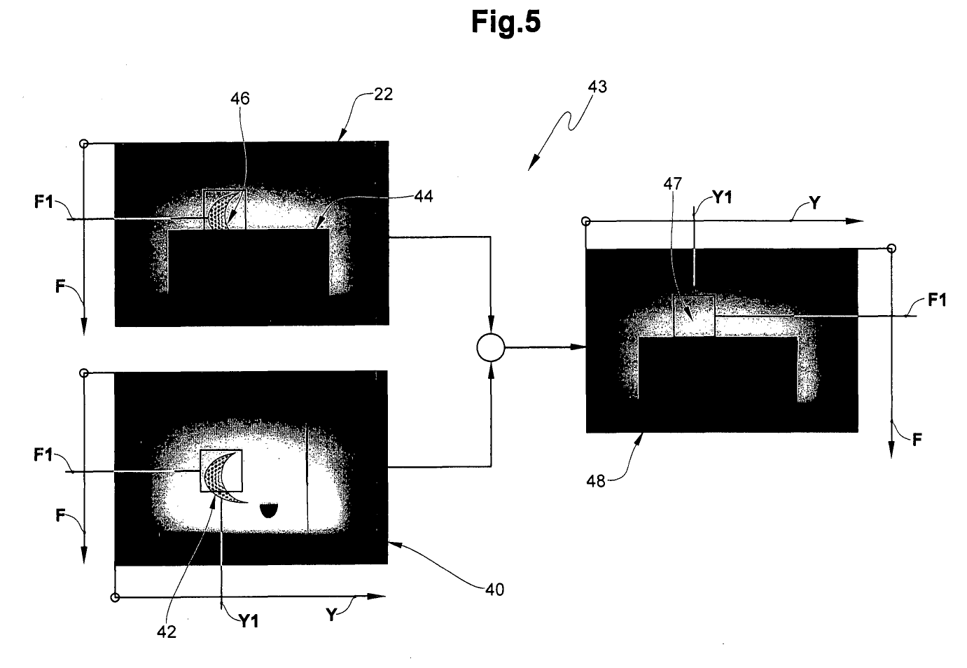

By using FIG. 5, the mode of action of an image pre-processing system 43 in the sense of the invention will be explained. The basis used for the image pre-processing 43 is a reference image which corresponds to the second silhouette 40 shown in FIG. 4. The current image 22 corresponds to a third silhouette, which is based on the second silhouette 40 but has a black rectangular region 44 assigned to a corresponding print shop product. In the image processing unit, the reference image forms a reference value and the current image 22 an actual value. As a result of the comparison of the actual value with the reference value, for example, a potential irregularity 46 at the coordinates F1, Y1 in the current image 22 can be determined as an actual irregularity 42 of the conveying element at the coordinates F1, Y1, since this irregularity 42 has been learned in a preceding setup operation. The actual irregularity 42, cited as representative of a large number of irregularities, was learned by the apparatus in a setup operation preceding the production operation now being explained. To this end, all the optically detectable differences between an ideal image formed by the first silhouette and the reference image 40 formed by the second silhouette at the same F/Y coordinates were interpreted as actual irregularities 42 if they exceeded the threshold value of the significance required for the purpose. In the present case, for each conveying element, an ideal image and a reference image were produced for this purpose, in order that particularly reliable detection values could be achieved. For this purpose, in trial operation the ideal images and the reference images were stored in a memory to which the image processing unit has access, together with a serial number assigned to the respective conveying compartment 2, 2a. Since, in the present case, the potential contaminant 46 was detected as an actual contaminant 42, it is excluded from further image processing, such as downstream contour detection. In the present case, this is done by the actual irregularities/contaminants 42 deemed to be significant and having the coordinates F1, Y1 being represented as a white, so-called blind zone 47 at the corresponding coordinates F1, Y1 in an intermediate result in the form of a fourth silhouette 48.

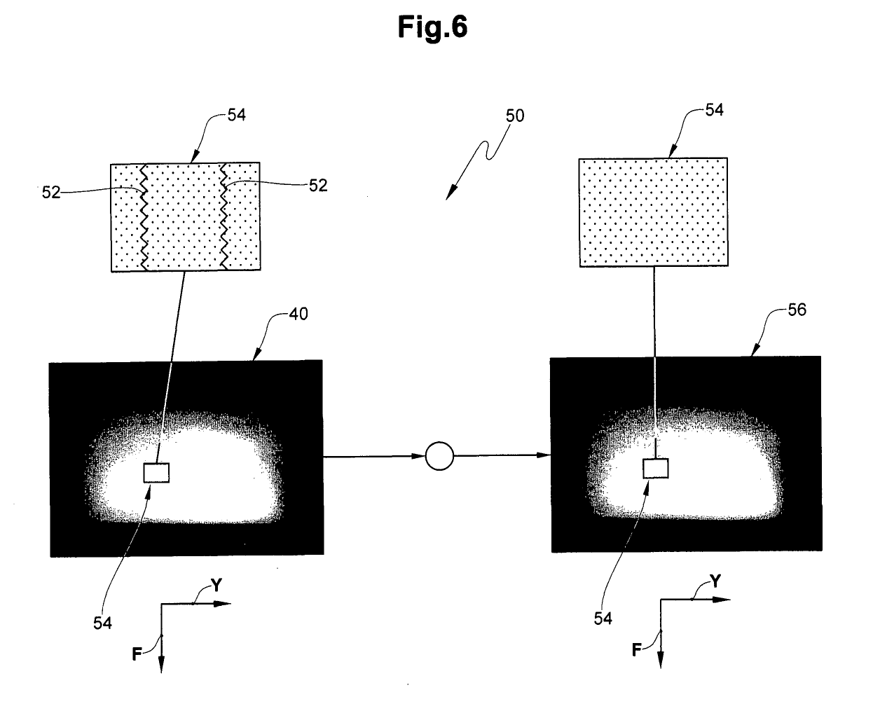

Further image pre-processing 50 will be explained by using FIG. 6. In the present case, each conveying compartment has a large number of relatively thin wire-like antistatic elements 52. Although these are detected by the optical sensor, on account of their relatively thin wire-like geometry they can be ignored with regard to a decision relating to the presence of irregularities such as dirt or cracks in the conveying compartment. Therefore, the representation of the antistatic elements 52 is understood as interference variable and not as an irregularity in the sense of the invention. In the present case, the antistatic wires 52 in an arbitrarily selected image detail 54 from the digitized image are represented by a certain number of pixels. The total quantity of pixels from each image within the entire recording area forms a total number of pixels. Since the certain number of pixels in relation to the total number of pixels contains a comparatively negligible amount of image information, the pixels showing the irregularities are removed from the current image by computation with a median function and thus excluded from subsequent image processing. Accordingly, the antistatic wires 52 are no longer contained in the fifth silhouette 56.

In trial operation, despite the removal of the antistatic elements 52 by computation from the second silhouette 40 and from the third silhouette before the production of the fourth silhouette 48, reliable detection of defective print shop products was achieved. The median function was likewise carried out in the image processing unit, which was assigned to the optical sensor or contained in the latter.

1. An optical control method for the postpress processing of flat print shop products (8, 8a, 8b), in which the flat print shop products (8, 8a, 8b) are led by a conveying means (4) along a conveying path (9) past at least one optical sensor (16), the method comprising:
registering current images (22) with the optical sensor (16) which form actual values in an image processing unit;
comparing the actual values in the image processing unit with at least one previously defined reference value;
generating at least one signal (17) in accordance with a comparison result from the image processing unit
showing at least portions of the conveying means (4) in the current images (22) which have irregularities (42);
assigning the irregularities (42) to at least one conveying element (2, 2a, 2b) of the conveying means (4); and
excluding the image processing unit from further image processing pixels from digitized current images (22) which, as compared with at least one reference value, represent at least one irregularity (42).

2. The method as claimed in claim 1, wherein the comparison of the actual value with the reference value is carried out periodically.

3. The method as claimed in claim 1, wherein the at least one signal (17) is generated when exceeding and/or falling below at least one threshold value during the comparison.

4. The method as claimed in claim 3, further comprising:
using the at least one signal (17) as a basis for deciding about subsequent treatment of the at least one conveying element (2, 2a, 2b) or of the conveying means (4).

5. The method as claimed in claim 3 further comprising:
forming the at least one threshold value by a predefined minimum number of pixels.

6. The method as claimed in claim 1, further comprising:
entering the reference value prior to production operation, from a data library or on the basis of at least one reference image (40) previously registered by the optical sensor (16).

7. The method as claimed in claim 6, wherein each conveying element (2, 2a, 2b) is assigned a reference image (40).

8. The method as claimed in claim 6, wherein the reference image (40) does not show any print shop products (8, 8a, 8b).

9. The method as claimed in claim 5, further comprising:
electronically removing irregularities (42) registered by the optical sensor (16), prior to the comparison of the actual values with the at least one reference value, which are represented by a certain number of pixels, from the current image (22) with a function if this number of pixels is lower than the threshold value and/or falls below a specific, previously definable ratio to the total number of pixels of the digitized image.

10. An apparatus for the optical control of flat print shop products (8, 8a, 8b), the apparatus comprising:
conveying means (4) for conveying the flat print shop products (8, 8a, 8b);
a digitizing unit and an image processing unit, the conveying means (4) arranged in such a way that the flat print shop products (8, 8a, 8b) can be transported along a conveying section (9) past at least one optical sensor (16), the optical sensor (16) being connected to the image processing unit via the digitizing unit, and the image processing unit having a comparison function for comparing a digitized current image (22) registered by the optical sensor with at least one reference value stored in a memory, wherein the optical sensor (16) is set up to register current images (22) which show at least portions of the conveying means (4) which have irregularities (42), and the image processing unit is set up to detect irregularities (42) of the conveying means (4) as such and to exclude from further image processing pixels from digitized current images (22) which, as compared with the at least one reference value, represent at least one irregularity (42).

11. The apparatus as claimed in claim 10, wherein the image processing unit is connected to a data library.

12. The apparatus as claimed in claim 10, wherein the image processing unit is connected to a communication means for the output of a signal (17).
